(19) United States
(12) Patent Application Publication
(10) Pub. No.: US 2002/0006746 A1
(43) Pub. Date: Jan. 17, 2002

(54) Insulation-displacement terminal fitting

(76) Inventors: Masahide Hio, Yokkaichi-City (JP); Eiji Kojima, Yokkaichi-City (JP)

Correspondence Address: CASELLA & HESPOS, 274 MADISON AVENUE, NEW YORK, NY, 10016

(21) Appl. No.: 09/893,919

(22) Filed: Jun. 28, 2001

(30) Foreign Application Priority Data
Jul. 14, 2000 (JP) 2000-214395

(51) Int. Cl. H01R 4/24

(52) U.S. Cl. 439/397

(57) ABSTRACT

An insulation-displacement terminal fitting (10) has cutting blades (20) formed by making cuts in side walls (22) of the insulation-displacement terminal fitting (10) and bending cut portions at right angles to face each other and to define a press groove (24) therebetween. The press groove (24) is defined by contact edges (25) that are spaced apart by a distance that is slightly smaller width than the diameter of a core (Wa) of the coated wire (W). Step edges (26) extend outwardly from the contact edges (25) at right angles to the side walls (22). Guide edges (27) extend up from the step edges (26). The distance between the guide edges (27) is greater than the distance between the edges (25). Cuts are made in a coating (Wb) by pressing the coated wire (W) against the right-angled step edges (26). The exposed core (Wa) then can be held between the opposite contact edges (25).

### BACKGROUND OF THE INVENTION

1. Field of the Invention

The present invention relates to an insulation-displacement terminal fitting.

2. Description of the Related Art

A conventional insulation-displacement terminal fitting is disclosed in Japanese Unexamined Utility Model Publication No. 2-150764 and also is illustrated in FIG. 7 herein. This terminal fitting has first and second opposed side walls 1 and first and second cutting blades 2 that project toward one another from the respective side walls 1 to define a press groove 3 between the cutting blades 2. The cutting blades 2 are formed by making cuts in the side walls 1 and bending the cut portions at right angles to the respective side walls 1. The press groove 3 is defined by first and second opposed contact edges 4 formed on the respective first and second cutting blades 2. The press groove 3 also is defined by first and second guide edges 5 that intersect the upper ends of the respective contact edges 4 at an obtuse angle to define first and second junctions 6. Thus, the press groove 3 is slanted to widen toward its upper end along regions above the junction 6 and bounded by the guide edges 5.

A coated wire W can be introduced between the guide edges 5 of the press groove 3 and then pushed down between the contact edges 4. The wire W has an insulating coating Wb that is cut at the junctions 6 of the guide edges 5 and the contact edges 4. Thus, contact is established with a core Wa of the wire W while the core Wa is held tightly between the contact edges 4 of the press groove 3.

Forces exerted by the wire W or other forces on the cutting blades 2 may cause the spacing between the cutting blades 2 to become wider. Thus, when the coated wire Wb is pushed in, the junctions 6 may slip along the outer circumferential surface of the coated wire Wb while the spacing between the cuffing blades 2 becomes wider. As a result, the coating Wb may not be cut sufficiently.

The present invention was developed in view of the above situation and an object thereof is to securely cut a coating of a coated wire.

### SUMMARY OF THE INVENTION

The invention is directed to an insulation-displacement terminal fitting with a base wall and first and second side walls that extend away from the bottom wall. At least first and second cutting blades extend toward one another from the respective first and second side walls and define a press groove therebetween. A coated wire can be pushed into the press groove to cut an insulation coating of the wire and to bring a core of the wire into contact with the cutting blades.

The press groove is defined by opposed contact edges formed on portions of the respective cutting blades closer to the base wall. The contact edges are spaced apart a sufficient distance for contacting the core and tightly holding the core between the contact edges. Opposed guide edges are formed on the respective cutting blades further from the base wall than the contact edges. The distance between the guide edges exceeds the distance between the contact edges. The press groove also is defined by substantially right-angled step edges that extend outwardly from the respective contact edges to the corresponding guide edges.

The cutting blades preferably are formed by cutting the first and second opposed side walls and bending the respective cut portions to substantially face each other. Thus, the press groove is defined between the inwardly bent cutting blades.

The coating is cut while the wire passes the step edges and the exposed core then is held tightly between the contact edges to establish a contact. The step edges are at a substantially right-angle to the side walls and to the direction of pushing the wire. Therefore, the step edges can bite sufficiently into the coating to securely cut the coating even if the space between the cutting blades becomes slightly wider. Furthermore, the right-angle alignment of the step edges prevents a cam or ramp effect as the wire is pushed against the step edges. Thus, there is a reduced tendency to widen the space between the side walls.

The space between the opposed contact edges may be narrowed gradually along the wire pushing direction. Thus, the exposed core enters the narrowing portion of the press groove between the contact edges while biting in the contact edges. Consequently, the core establishes contact with enhanced reliability.

The space between guide edges may be widened gradually at locations further from the base wall. Thus the coated wire can be introduced more smoothly into the press groove.

Corners between the step edges and the contact edges may be rounded off slightly. This construction can alleviate a concentration of stresses and can improve convenient handling of the terminal fitting while maintaining an advantage of satisfactorily cutting the coating of the coated wire.

The space between the opposed contact edges preferably is slightly narrower than the diameter of the core of the coated wire and/or the space between the opposed guide edges preferably is wider than the diameter of the core.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a perspective view partly cut away showing a first embodiment of the invention.

FIG. 2 is a section along 2-2 of FIG. 1.

FIG. 3 is a section along 2-2 of FIG. 1 when a connection by insulation displacement is completed.

FIG. 4 is a section of a second embodiment.

FIG. 5 is a section of a third embodiment.

FIG. 6 is a section of a fourth embodiment.

FIG. 7 is a section of a prior art insulation-displacement terminal fitting.

### DETAILED DESCRIPTION OF THE PREFERRED EMBODIMENTS

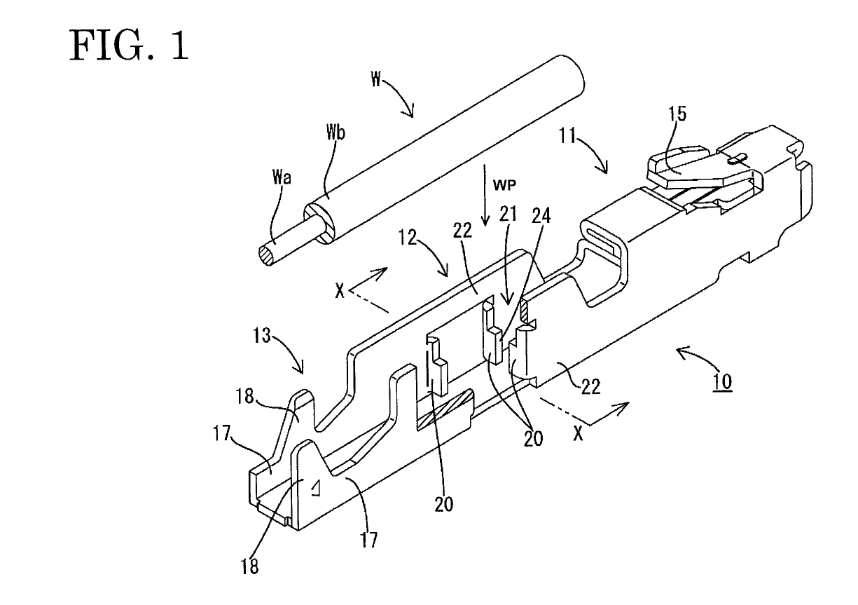

An insulation-displacement terminal fitting in accordance with a first embodiment of the invention is identified by the numeral 10 in FIGS. 1 to 3. The insulation-displacement terminal fitting 10 is used with a coated or insulated wire W. The wire W has a core Wa that preferably is made of twisted strands and insulation or coating Wb that preferably is made of a synthetic resin.

The insulation-displacement terminal fitting 10 is formed into the shape shown in FIG. 1 by successively cutting or stamping a metallic plate and then bending the metallic plate by means of a press. As a result of the forming steps, the insulation-displacement terminal fitting 10 has an engaging portion 11, an insulation-displacement portion 12 and a barrel 13 in this order from its leading end.

The engaging portion 11 is substantially in the form of a rectangular tube that extends in forward and backward or longitudinal directions. A metal locking portion 14 is formed at an upper or lateral wall of the engaging portion 11 by cutting and bending; and an elastic contact piece (not shown) is provided inside the engaging portion by folding back a tongue that extends from the front edge of a base wall. A tab of an unillustrated male terminal fitting can be inserted into the engaging portion 11 from front and can be brought elastically into a contact with the elastic contact piece.

Crimping pieces 18 project from short left and right side walls 17 at the rear end of the barrel 13, and are displaced longitudinally from one another. The coated wire W can be fastened to the insulation-displacement terminal fitting 10 by crimping, bending or folding the two crimping pieces 18 into connection with the coated wire W, while the core Wa of the wire W can be connected with the insulation-displacement portion 12.

The insulation-displacement portion 12 is in the form of a channel that is open upward or laterally, and comprises two pairs of blades 21 that are spaced apart in a longitudinal direction. The side of the insulation-displacement portion 12 into which the wire W is inserted will be referred to herein as the top. However, the terms top, bottom and similar terms are employed to provide a convenient frame of reference, and do not imply a required gravitational orientation Each pair of blades 21 comprises first and second cutting blades 20. The respective cutting blades 21 are formed by making cuts in first and second substantially parallel side walls 22 and bending the cut portions of the side walls 22 inwardly at substantially right angles. The cutting blades 20 in each pair are spaced apart and substantially oppose each other. Thus, a press groove 24 is defined between the cutting blades 20.

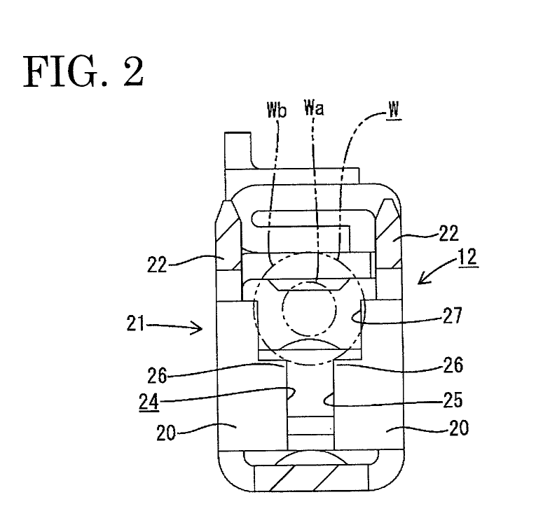

As shown in FIG. 2, the facing edges of the two cutting blades 20 have a stepped shape, such that the upper parts of the opposed cutting blades 20 are spaced further apart than lower parts of the opposed cutting blades 20. More particularly, the press groove 24 is defined by opposed contact edges 25 that are spaced from one another by a width slightly smaller than the diameter of the core Wa of the coated wire W. The press groove 24 is further defined by opposed guide edges 27 that are spaced from one another by a width that is greater than the distance between the contact edges 25. Step edges 26 extend substantially perpendicular to the side walls 22 and continuously between each respective contact edge 25 and the corresponding guide edge 27.

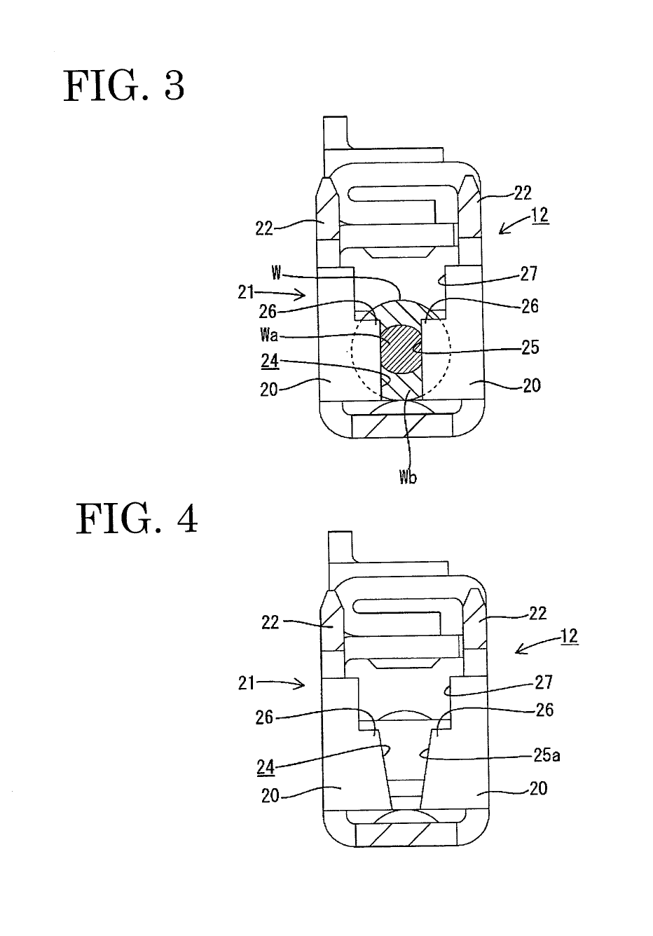

An end of the coated wire W can be placed between the guide edges 27 of the press grooves 24 of the front and rear blades 21, as shown by the arrow WP in FIG. 1. The coated wire W then is pushed between the front and rear blades 21 and at the front and rear sides of the blades 21 by an unillustrated pressing jig that moves in a wire pressing direction WP. Cuts are made in the coating Wb as the coated wire W is pressed against the corners of the step edges 26 of the press groove 24, as shown in FIG. 2. Continued pressing of the wire W causes additional cutting of the coating Wb and the exposed core Wa eventually is held tightly between the opposed contact edges 25, as shown in FIG. 3, to establish a contact.

The coated wire W is fastened to the barrel 13 at a position behind the insulation displacement blades 21, while the core Wa is connected by insulation displacement.

The step edges 26 of this embodiment that cut the coating Wb of the wire W are aligned at substantially right-angles to the wire pushing direction WP and at substantially right angles to the side walls 22. Accordingly, the corners of the step edges 26 adjacent the contact edges 25 are capable of sufficiently biting into and cutting the coating Wb even if the spacing between the cutting blades 20 becomes slightly wider as the coated wire W is pushed in. As a result, the core Wa is securely exposed to establish a contact with an enhanced reliability.

FIG. 4 shows a second embodiment in which a contact edges 25a of the press groove 24 converge gradually toward the closed bottom end of the press groove 24. Other elements of the second embodiment are similar to or the same as elements of the first embodiment. These similar elements are not described, but are identified by the same reference numerals as in the first embodiment. The step edges 26 cut the coating Wb and expose the core Wa as the wire W is pushed down. The contact edges 25a of the cutting blades 20 in the second embodiment then bite into the core Wa and an electrical contact can be established with an even better reliability.

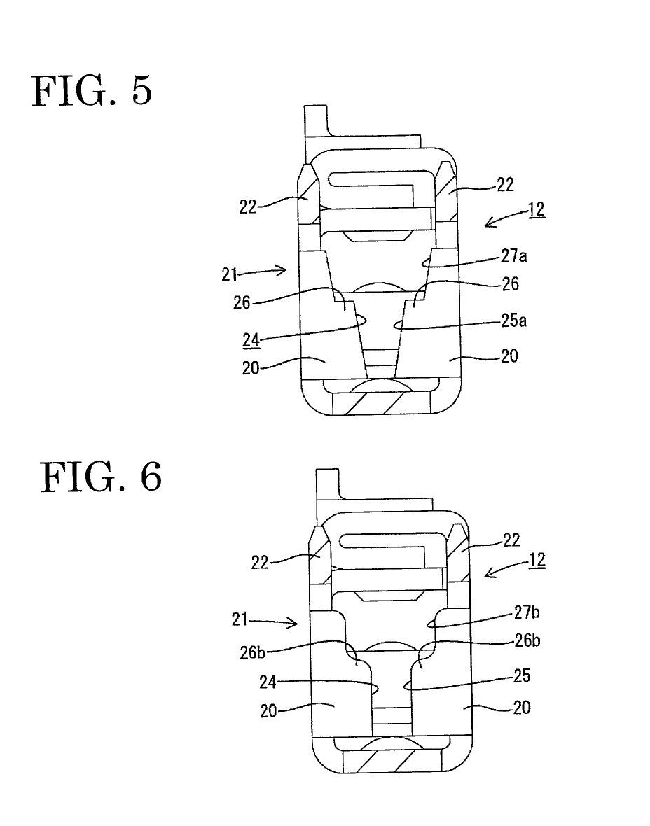

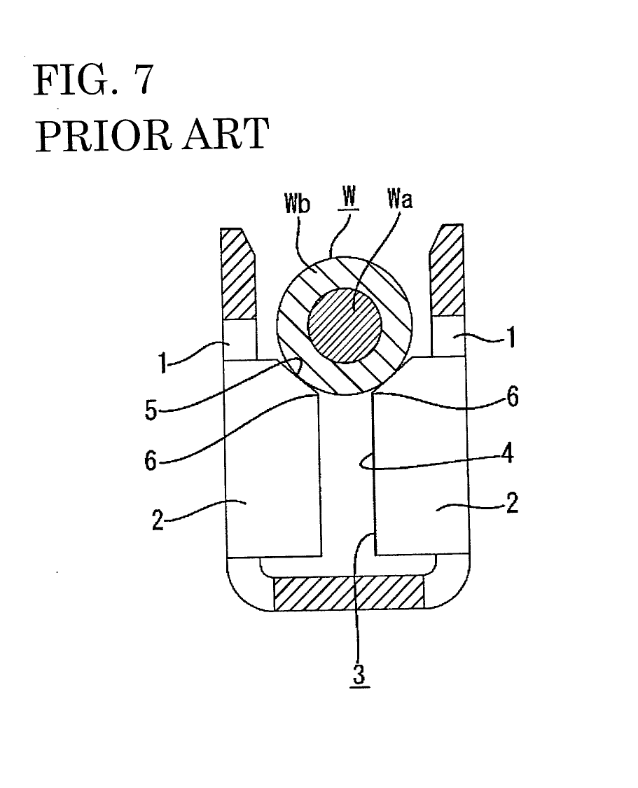

A third embodiment is shown in FIG. 5, and differs from the second embodiment in that the space between the opposed guide edges 27a is gradually widened toward its upper opening edge. This construction enables the coated wire W to be introduced more smoothly into the press groove 24.

A fourth embodiment is shown in FIG. 6, and differs from the first embodiment in that corners at the top of the guide edges 27a, corners between step edges 26b and the guide edges 27a and corners between the step edges 26b and the contact edges 25 are rounded off slightly. This rounding of the corners can alleviate concentration of stresses and improve convenience of handling the terminal fitting, while satisfactorily cutting the coating Wb of the coated wire W.

What is claimed is:

1. An insulation-displacement terminal fitting (10) for use with a wire (W) having a core (Wa) and a coating (Wb) around the core (Wa), comprising: first and second opposed side walls (17), portions of the respective first and second side walls (17) being cut and bent toward one another to define first and second opposed cutting blades (20), the opposed cuffing blades (20) defining a press groove (24) therebetween, the press groove (24) having an open end, opposed guide edges (27; 27a; 27b) extending from the open end and being spaced apart sufficiently for receiving the wire (W), first and second step edges (26; 26b) extending toward one another from ends of the respective guide edges (27; 27a; 27b) remote from the open end of the press groove (24), the step edges (26; 26b) defining a minimum spacing for cutting into the coating (Wb) of the wire (W) pushed into the press groove (24), and contact edges (25; 25a) extending from the step edges (26; 26b) away from the open end of the press groove (24) and being spaced for tightly holding the core (Wa) between the contact edges (25; 25a).

2. An insulation-displacement terminal fitting according to claim 1, wherein a distance between the opposed contact edges (25a) is narrowed gradually at further distances from the step edges (26).

3. An insulation-displacement terminal fitting according to claim 1, wherein a distance between the guide edges (27a) is widened gradually at further distances from the step edges (26).

4. An insulation-displacement terminal fitting according to claim 1, further comprising rounded corners between the step edges (26b) and the contact edges (25).

5. An insulation-displacement terminal fitting according to claim 1, wherein a distance between the contact edges (25; 25a) is less than a diameter of the core (Wa) of the coated wire (W), and wherein a distance between the guide edges (27; 27a; 27b) is wider than the distance between contact edges (25; 25a).

6. An insulation-displacement terminal fitting (10), comprising a base wall, first and second opposed substantially parallel side walls (22) extending from the base wall, first and second substantially planar cutting blades (20) cut from portions of the respective first and second side walls (22) and projecting toward one another to define a press groove (24) therebetween, the press groove (24) being defined by opposed contact edges (25; 25a) substantially adjacent the base wall, step edges (26; 26b) extending substantially perpendicularly toward the respective side walls (22) from locations on the respective contact edges (25; 25a) remote from the base wall, and opposed guide edges (27; 27a; 27b) extending from the step edges (26; 26b) and away from the base wall.

7. The insulation-displacement terminal fitting (10) of claim 6, wherein the contact edges (25) are substantially parallel to the side walls (22).

8. The insulation-displacement terminal fitting (10) of claim 7, wherein the guide edges (25) are substantially parallel to the side walls (22).

9. The insulation-displacement terminal fitting (10) of claim 7, wherein the guide edge (25) of each said cutting blade (20) are substantially parallel to the respective contact edge (27).

10. An insulation-displacement terminal fitting according to claim 6, wherein a distance between the opposed contact edges (25a) is narrowed gradually at location closer to the base wall.

11. An insulation-displacement terminal fitting according to claim 10, wherein a distance between the guide edges (27a) is widened gradually at further distances from the step edges (26).

12. An insulation-displacement terminal fitting according to claim 6, further comprising rounded corners between the step edges (26b) and the contact edges (25).

13. An insulation-displacement terminal fitting according to claim 6, further comprising rounded corners between the step edges (26b) and the guide edges (26).

14. An insulation-displacement terminal fitting according to claim 6, further comprising rounded corners at locations on the guide edges (26) furthest from the base wall.
